(19) United States
(12) Patent Application Publication
(10) Pub. No.: US 2011/0131493 A1
(43) Pub. Date: Jun. 2, 2011

(54) METHOD, SYSTEM AND COMPUTER PROGRAM FOR DISTRIBUTING ALTERNATE VERSIONS OF CONTENT

(76) Inventor: Kurt Dahl, Vancouver (CA)

(21) Appl. No.: 12/954,799

(22) Filed: Nov. 26, 2010

Related U.S. Application Data
(60) Provisional application No. 61/264,722, filed on Nov. 27, 2009.

(51) Int. Cl. G06F 3/048; G06F 15/16

(52) U.S. Cl. 715/716

(57) ABSTRACT

A method, system and computer program for distributing alternate versions of content is provided. The method enables one or more users to create an alternate version of content. The content provider creates a plurality of different versions of content. Each of the different versions is divided into segments. The segments correspond to segments of the alternate version. The one or more users can create the alternate version of the content by selecting, for each of the segments of the alternate version, one of the segments from one of the different versions.

### CROSS REFERENCE

This patent application claims priority benefit to U.S. Provisional Patent Application No. 61/264,722, filed Nov. 27, 2009, and which is incorporated herein by reference.

### FIELD OF THE INVENTION

The present invention relates generally to distributing content. The present invention more specifically relates to distributing alternate versions of content.

### BACKGROUND OF THE INVENTION

Musical works, whether in analog or digital form, have traditionally been sold to consumers in relatively non-interactive forms. For example, a compact disk or digital audio file containing a pre-recorded musical performance enables a user to listen to a reproduction of the original musical performance. However, the user is not expected or encouraged to alter materially the underlying music.

One of the reasons music sales are not what they used to be is that other, more engaging forms of entertainment (video games, movies, concerts, etc.) have proven more popular. The 21st century entertainment industry is becoming more and more based on empowering consumers to create a “read and write” culture, as opposed to the “read only” culture that defined the 20^{th} century. The products that are popular today (Facebook™, Myspace™, personalized phones, iPods™, etc.) all have one thing in common: they are interactive, and can be personalized to reflect—and in fact define—an individual's personality.

In the prior art, users have been given the ability to dissect a musical work into its basic instrumental parts (guitar, vocals, drums, etc.), and adjust the levels of each of these parts accordingly. These technologies have put users in the role of producer, allowing users to adjust the volume or equalization of a given work's constituent components. However, they failed to engage people without extensive knowledge or interest in recording technology and the mixing of songs.

There are currently many solutions reflecting the idea of a “read and write” culture for music. There are online studios, for example, that allow musicians to upload their tracks and mix them online. There are also sites that allow a user to use a 32-channel mixer and edit their favorite songs, which require a fair amount of mixing/engineering knowledge. In the past year, for example, musical artists Nine Inch Nails™ and Radiohead™ have each released music to the public that allowed users to manipulate each of the individual instruments (guitar, vocals, drums, keyboards, etc.) contained in the songs, thereby ‘creating’ their own version of the material.

While these solutions appeal to the interactivity demanded by tech savvy consumers, they only do so in a limited way. For the average music fan, unfamiliar with the recording and producing/mixing process, the opportunity to turn up drums or put reverb on vocals has little appeal.

There are also many high-end solutions that enable professional recording engineers to digitally process, manipulate, and modify pre-recorded music. The engineers are not constrained in the allowed amount of musical processing and modification. They are therefore given too much freedom but also are faced with extremely complex systems. There is not enough structure and guidance that would allow these solutions to be used by novice users.

While these technologies have put users in the role or producer, allowing them to remix and adjust levels as they see fit, they have failed at truly involving users in the creative process.

Rather than give users complete rein over the ‘mix’ of a given song, what is needed is a means for users to put together various segments of a song that have been pre-recorded by their favourite artists, thereby leaving the music to the musicians, and the interpretation and organization of that music to their fans.

### SUMMARY OF THE INVENTION

The present invention provides a system for enabling a user to create an alternate version of content defined by a plurality of segments, the system, comprising: (a) a server linked to a music database; (b) a configuration tool linked to the server, the configuration tool enabling a content owner to provide to the server a plurality of different versions of content divided into segments that correspond to the segments of the alternate version, the different versions of content being stored by the server in the music database; and (c) a user interface enabling the user to create the alternate version of the content by selecting, for each of the segments of the alternate version, one of the different versions, the server operable to assemble the alternate version from the different versions of content stored in the music database.

The present invention also provides a computer-implemented method for enabling a user to create an alternate version of content defined by a plurality of segments, the method comprising the steps of: (a) enabling a content owner to provide to a server a plurality of different versions of content divided into segments that correspond to the segments of the alternate version, the different versions of content being stored by the server; and (b) enabling, by means of a user interface linked to the server, the user to create the alternate version of the content by selecting, for each of the segments of the alternate version, one of the different versions, the server operable to assemble the alternate version from the different versions of content stored.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates a system implementation in accordance with the present invention.

FIG. 2 illustrates a user interface for accessing the server in accordance with the present invention.

FIG. 3 illustrates an artist upload page for a first segment in accordance with the present invention.

FIG. 4 illustrates an artist upload page for a second segment in accordance with the present invention.

FIG. 5 illustrates an artist upload page for a fourth and final segment in accordance with the present invention.

FIG. 6 illustrates a possible division of a song by an artist and a possible customization of the song by a user.

FIG. 7 illustrates a database schema operable with the present invention.

### DETAILED DESCRIPTION

The present invention relates to distributing content and more specifically relates to distributing alternate versions of content. The content may, for example, comprise audio, video, text-based or other media content. The following description provides examples for use of the present invention in distributing alternate versions of audio content but it should be understood that this in no way limits the present invention. For example, the present invention can also be used for arranging pre-recorded versions of segments of video, be it short-length music videos, or full-length feature films, or could be used for arranging pre-written versions of segments of text, such as to provide a custom e-book.

The present invention enables a user to interactively create new arrangements of pre-recorded musical works, based on the interaction between musicians and fans. A content owner, such as an artist, provides alternate versions of the works having a plurality of segments. The alternate versions can, for example, be focused on different types of the same song (rock, jazz, country, high-energy, mellow, etc.). The user can arrange versions of the segments to create a new work.

The present invention can be distinguished from prior art systems in at least two primary ways: (1) rather than forcing users to become a ‘producer’ and vary, for example, the levels of a guitar or drum track, the invention enables users to become the musician, deciding how the song will be put together; and (2) the invention is easy to use and does not require the knowledge of operating complex devices such as mixers. The invention enables users to be creators rather than producers. It enables music fans to engage in the creative process of their favorite artists to truly ‘create’ a song within the parameters determined by those artists (or their producers and/or record labels).

It is common for artists to try different things with their songs, before picking the one version they think would be most ‘commercially viable’, or best represent their artistic vision. The present invention enables artists to leverage the value in opening up these decisions to the consumer. It enables consumers of content to give effect to a manageable number of consumer choices, thus enabling consumers to customize their consumption of content in a relatively inexpensive way.

The invention also provides an analytic engine that can be used as an analytical tool to enable artists, record labels, producers, and any other investor in musical talent to develop a meaningful distribution model for content.

In the past, artists and their handlers had to guess what might sell before releasing a product, based on their combined knowledge and experience in the industry and consumer trends in terms of taste. Sometimes these subjective judgments are incorrect, at least for a significant number of people.

The analytic engine provides information including, but not limited to, specific content versions that are being created and consumed by users (including user demographic information correlation), which content versions are most popular (again broken down by user demographic information), where the combinations were created (for example, by use of GPS coordinates or other location information), when the combinations were created, and on which social networks the combinations are shared. Artists, record labels and producers can use this information to make educated decisions on what might sell before releasing products and booking venues for tours.

The present invention enables content distributors to sample consumer reaction to certain types of music in different markets, and adjust their releases according to this information. For example, an artist could pre-release different content versions of their next big single in various markets, and find out that the average fan prefers the ‘piano chorus’ instead of the ‘hard rock guitar chorus’. This will allow artists and other stakeholders to test their assumptions about a given demographic of fans, which could be invaluable information as the music industry continues to be consumer-driven. As this information is accumulated, it can be sold back to record labels and other interested parties. Therefore, rather than guess what might sell and then spend money trying to push it on music fans, the invention can let the supply of music evolve based on consumer demand. As such, it creates an entirely new distribution model for artists and labels. In this way, the invention may be seen as enabling democratization of the creative process.

For artists especially, the invention enables them to provide fans with something special, an inside glimpse into their creative process, which will separate them from the barrage of other bands that they compete with online. Further, it empowers artists by opening up communication between them and their fans, which is important in the digital distribution model.

The present invention also comprises a user interface for enabling a user to navigate through alternate versions of segments of the same song, with the end result being a ‘customized’ piece of music for distribution to a mobile device or computer. The user interface may enable users to choose, at particular segment points, from various pre-recorded versions of the same song in real time, thereby assembling their own personalized song. The method also involves the use of multiple digital files simultaneously, which are turned on or off depending on the choices of the user. It should be understood that the pre-recorded segment versions are created by the artist such that the user is creating ‘customized’ music by using pre-recorded segment versions emanating from the artist as building blocks.

A musical work may therefore be stored and represented on a digital medium in the form of a digital database comprising a plurality of alternate recorded versions of various segments of the same song. Each sequence position in the song may represent an entire take by the artist of a given segment of that song. The user decides which version is played for each segment of the song, and the assembly of the selected versions makes up the complete musical work.

This digital medium is provided as input to a digital processor system as described herein. A user then interactively selects a plurality of the fixed versions in real time, and thereby creates a customized song based on a set of defined versions that have been previously recorded by the artist. Interactive selection of versions is performed using a menu-driven, graphical user interface. At each segment of the song, the user may pick one of a plurality of versions recorded by the artist. The technology allows for the assembly of these versions in real time, as the song is played to the user, thereby creating a new arrangement of the musical work.

Each musical version may provide a different mood or atmosphere to the song, in accordance with the artists' wishes. An example would be offering a hard rock styled chorus, as well as a country rock styled chorus, along with a reggae type chorus. In this way, the invention strikes a balance between user interactivity and artistic expression and control. Users can only change the song within certain parameters defined by the artist.

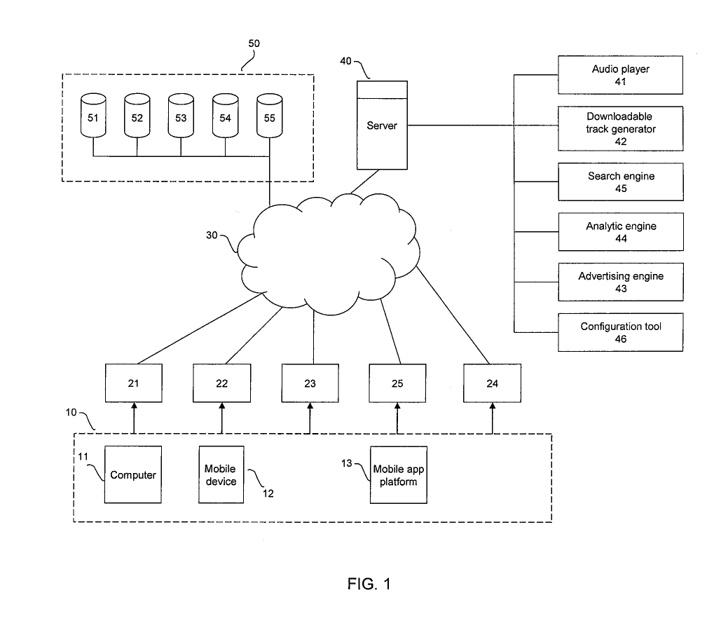

FIG. 1 illustrates a system implementation in accordance with the present invention. In this implementation the system is accessible to a user in a cloud computing environment, but it should be understood that other systems can be provided for accessing the system as a program on a computer, or on a distributed network basis.

The system enables access to users and artists by a number of interfaces.

A server (40) linked to a database (50) architecture is provided for administering the system. A user can access the server (40) via a number of user interfaces (10), including for example by standard web browsers (11), mobile web browsers (12) and mobile platform applications (13). These user interfaces (10) may access the server via one of the channels (21 through 25), including for example a dedicated website (21), social networking application (22, 23), mobile device based application (25), and others interfaces supported by a set of Application Programming Interfaces (APIs) (46) for directly accessing the server from other applications (24). The user interfaces (10) may be operable to provide location information to the server, whether by GPS location functionality of a mobile device, IP address localization information of a mobile or desktop device, or other location-based information.

For example, the server can be made accessible by APIs from a music management application, such as iTunes™. The user may access songs that offer alternate content versions by the server by searching artists and songs. An icon or other indicator may be used to decipher which songs offer alternate content versions, which can simply be clicked on to access the server.

Users may interact with the same underlying server services regardless of which channel they access the application with, however the physical presentation of these services may vary across user interfaces to accommodate different screen sizes or layouts. The API may allow both industry standard and customized applications to access the server. It may provide a “translation” between the server data and application data being sent to the server by users. By using existing technology, the server API may automatically detect the browser or application type to customize the user interface for accessing the present invention, for example by determining the appropriate screen size and resolution to operate in.

The server may comprise or be linked to an audio player (41), a downloadable track generator (42), a search engine (45), an analytic engine (44) an advertising engine (43) and a configuration tool (46). The server may further be linked to one or more databases (50) comprising an artist database (51), customer database (52), music database (53), advertising database (54) and social network database (55). The databases may be implemented by relational databases.

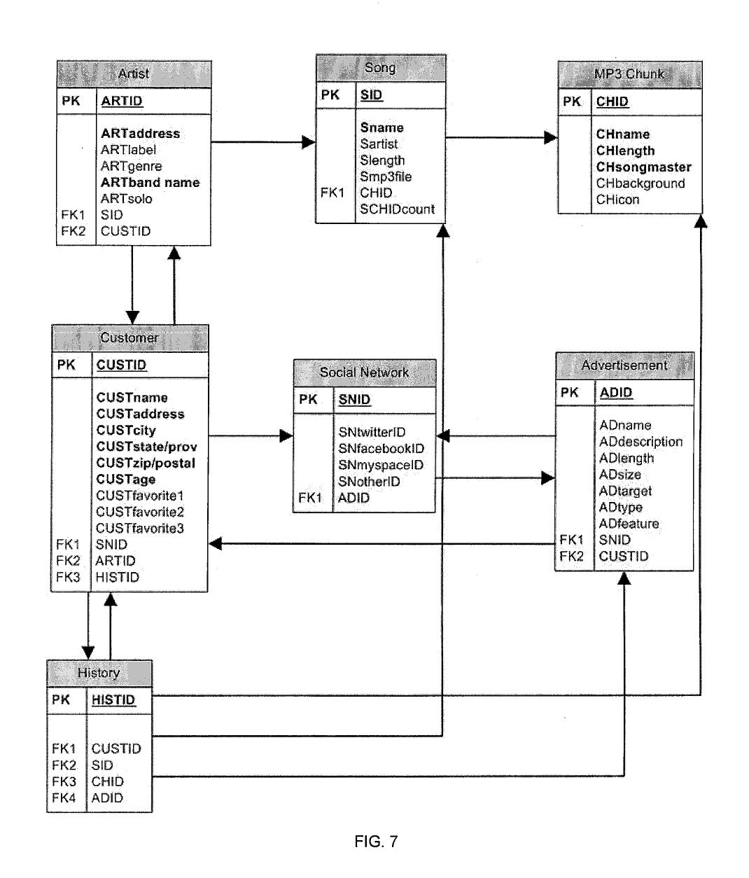

FIG. 7 illustrates a database schema operable with the present invention. For example, the artist database may include, for each artist ID, fields for the artist's address, label, genre, name, and an indication of whether the artist is an independent (solo) performer or signed to label, song ID, and customer ID. The customer database may include, for each customer ID, fields for name, address, city, province/state, zip/postal, age, favorite 1 . . . n to represent favorite artists that the customer is a fan of, social network user information, artist ID, and history ID to link to a history database that tracks user's song version selections, how much time they spent creating mixes, which artists did they create mixes for, what versions they purchase, etc. The music database may include fields for song name, artist, length, file, version ID, and how many segments are in a particular song. The music database may include, for each version ID, fields for name, length, song master, background and icon. The advertising database may include, for each advertisement ID, name, description, length, size, target, type, social network ID and customer ID. The social network database may include, for each social network ID, a first social network platform credential, a second social network platform credential, etc., and an advertisement ID.

The configuration tool enables access to the server by an artist, via a website, an application, a mobile device application, etc. An artist may provide the server with alternate versions of content using the configuration tool. The alternate versions of content may comprise a plurality of segments.

For example, an artist may record different takes of different parts of a song in the studio. For example, the artist may record the ‘face-melter guitar solo’ as one take and the ‘intimate, candle-lit solo’ as another take. The artist could also provide as alternate takes: alternate lyrics in two takes; a ‘hidden’ drum breakdown; an alternate ending; or a ‘country’ outro to an otherwise ‘rock’ song. Many other examples are possible, and contemplated herein.

Alternatively, the artist may provide full songs as the alternative versions and later specify, by means of the configuration tool, the locations within the song that segments are changeable by the user.

The configuration tool may also enable an artist (or publisher or other stakeholder) to customize the user interface accessible by a user, such as to customize the background image for the application, color schemes and images for user controls, icons to access the application commands/features within the application, pricing for accessing and/or downloading the content, and metadata such as song names, version names, band name, label, producer, guest artist credits, etc. All information provided by the configuration tool can be stored in the one or more of the databases.

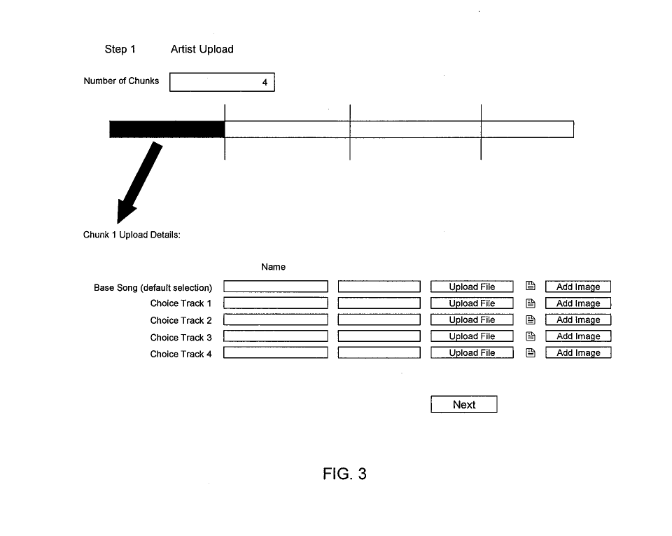

FIG. 3 illustrates an artist upload page for a first segment in accordance with the present invention. Each version of the segment may be provided in a common format, such as MP3. Each version is stored to the music database (53) by the server. The initial information submitted by the artist may be the number of segments the song will be divided into. The number of segments is stored in the music database (53). By specifying the number of segments, a set of one or more reference points in time (hereinafter “segment points”) may be generated and also stored to the music database.

Alternatively, the artist can upload a plurality of song versions as full songs and later associate segment points with the full songs. Thereafter, the versions are treated substantially similarly to the above referenced case.

Once the song is divided into segments, the artist may be prompted to upload the appropriate amount of versions (as files) for each segment, in order from start to finish. Although the amount of versions per segment may be technically unlimited, a setting may be configured for limiting the amount of versions to a maximum, for example ten, to avoid overwhelming users with too many choices. Each artist may be given discretion to determine the number of versions given to users in each section of the song, and thus there may be a finite set of versions that will be provided to users.

The first versions uploaded may be specified as the ‘default’ versions, or the versions that the artist has initially chosen as its pick for the segment. If users make no choice, this version is selected. If users are given no alternate versions for a given segment of the song, this default version will be the only track uploaded by the artist for that segment. The default versions may be adaptive to social trends, as discussed below.

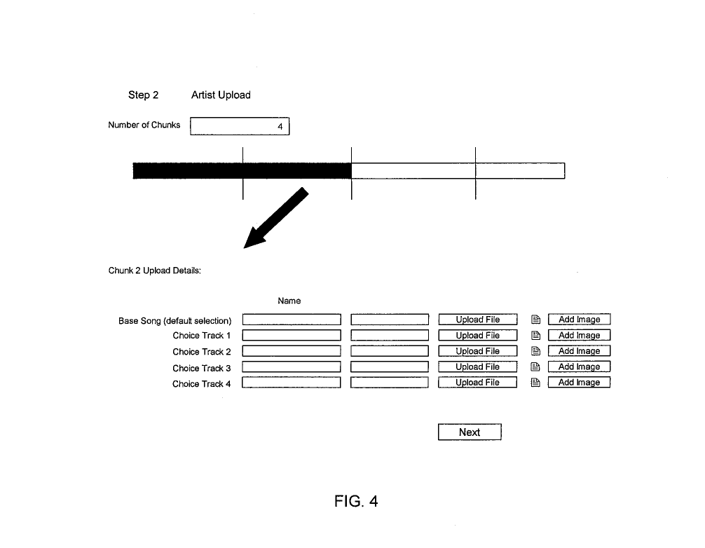

FIG. 4 illustrates an artist upload page for a second segment in accordance with the present invention. A graphical representation, such as the horizontal bar illustrated in FIG. 4, may be provided for indicating that the segment has been populated with versions by the artist. The artist may provide versions as described above.

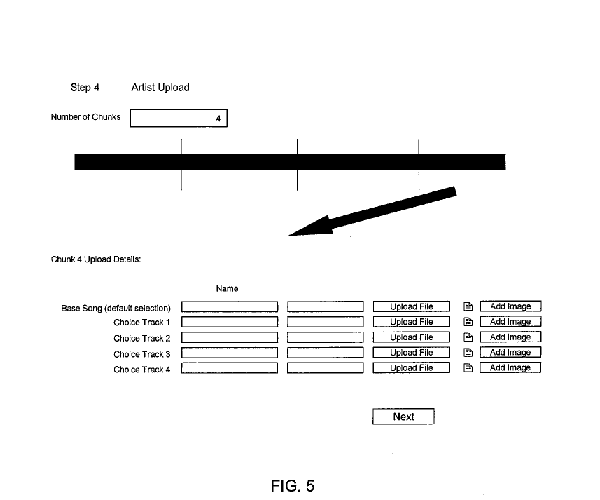

FIG. 5 illustrates an artist upload page for a fourth and final segment in accordance with the present invention. The artist may provide versions as described above.

On a practical level, artists may be required to ensure that each version within each segment flows into the following segment seamlessly, which is quite easy on a technical level when utilizing modern recording technology. This is also quite easy if the artist chooses to first upload full song versions and later associating segment points with the song. The challenge lies in making the parts flow together on an artistic or creative level, such that the song will retain its overall integrity as a whole regardless of the versions chosen by the user, while still offering users versions that are different enough to warrant the selection process.

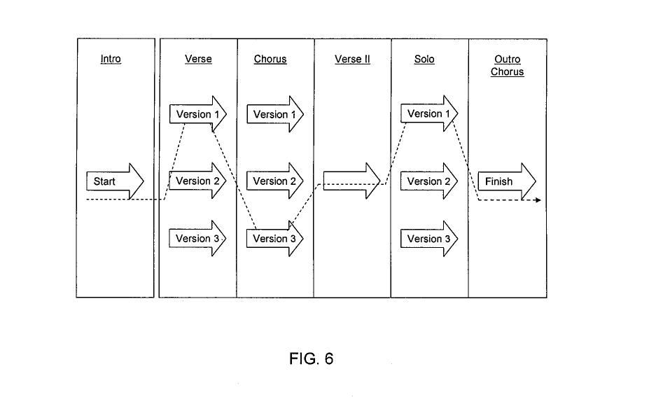

FIG. 6 illustrates a possible division of a song by an artist and a possible customization of the song by a user, illustrated by a dotted line. The artist in this example has divided the song into 6 segments: Intro, Verse, Chorus, Verse 2, Solo, and Outro Chorus. The artist has given the user no choices for the Intro, Second Verse, and Outro Chorus of the song, but has recorded different versions for Verse 1, the Chorus, and Solo. For example, perhaps Version 1 of the Solo segment of the song is a guitar solo with the band backing it up, while Version 2 is the ‘normal’ version of the song with a keyboard solo, while Version 3 is a drum solo. For the Verse 1 segment of the song, perhaps Version 1 is one set of lyrics, while Version 2 is the ‘regular lyrics’, while Version 3 is the regular lyrics but with another guest vocalist singing backups (which offers many possibilities for collaborations between artists, and between genres). The dotted line shows the path that this sample user took in this instance, opting for Version 1 in the Verse, Version 3 in the Chorus, and so on.

Note that the vertically centered set of arrows represents songs as they are traditionally known, that is without any versions being offered to users. Incidentally, if the user makes no choices, the song may be played in this manner, representing the ‘original’ (default) version of the given song according to the artist.

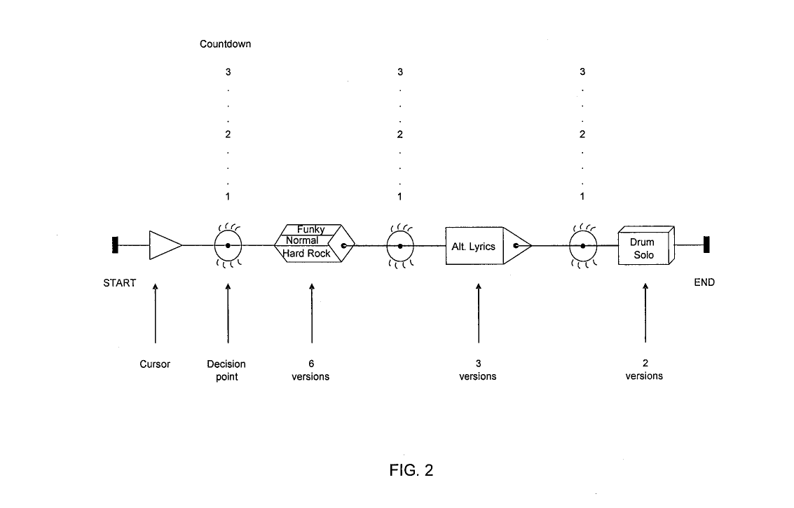

FIG. 2 illustrates a user interface for accessing the server in accordance with the present invention. The server may comprise an audio player, a downloadable track generator, a search engine, an analytics engine and an advertising engine.

The audio player (41) may access the music database (53) and assemble the segment versions into a stream that is played back to the user. It may store in the music database (53), in real time, the selections made by the user at each segment point. The audio stream may be played in full quality or at a lower level depending on the user level and configuration.

A user interface may be provided for enabling decision making by the user. For example, the horizontal line illustrated in FIG. 2 may represent playback of the song. One or more icons, such as flashing circles or other visually distinct shapes, may represent the segment points, before which the user must have made a selection for the coming part. If no selection is made prior to the song at the segment point being played, the default version, a preselected version, or a random version of the upcoming segment may be played back.

When the song starts, the cursor may start to move from left to right towards the next segment point. At any time before the segment point, the user may make a selection as to which version they would like for the coming segment. The user will be able to see a descriptor of the version for each segment point, represented by a version selector. For example, the version selector may be represented by a shape corresponding to how many versions are available (e.g., versions: 2=two-sided plate, 3=triangle, 4=square, 5 and above=barrel-type shape) at the segment point. The segments can coincide with any part of the song that the artists desires, such as the chorus, verse, bridge, solo, outro, intro, etc. In FIG. 2 for example, the 6 segment shape might coincide with the 1^{st} chorus, while the 3 segment shape might coincide with the 2^{nd} verse, and so on. It should be understood that the same shape could be used for all selections regardless of the number of versions that are selectable for any given segment.

At any time before the segment point, the user can manipulate the segment selector to select one of a plurality of versions. This can be accomplished using any input means, such as a touch screen feature on a mobile device, or by pressing up and down on a keyboard, trackball or other control. Optionally, a mobile device comprising gyroscopes and/or accelerometers may be used as an input device, in which case the user may “shake” the mobile device to select a randomization function that selects a random version for the segment point, tilt up/down to select versions and tilt left/right to select segment points. Randomization adds a gaming aspect to the selection of versions and helps indecisive users put together interesting and unique versions of the songs.

The user interface may also display a countdown (i.e. “3, 2, 1”) signifying that the user must make a version selection before the time is up. Failure to respond to the countdown may result in the current version continuing to be played, the default version being played, another preselected version being played, or a random version being played.

Once the user has made its choice and the cursor reaches the segment point, the version descriptor may flash, signifying that the corresponding version has been selected, and may continue to flash while that version is being played, signifying that the user's selection is indeed being played.

The straight lines between the segment selectors may represent those parts of the song in which the user has no choice.

Upon completion of playback and choice input, the user may download their customized song, which may include payment of a fee or agreement to pay a license fee when the song is consumed. The generated music file may also be stored virtually in the cloud and/or in the music database (53). The music generator may use the version selection for the segment points stored in the music database to assemble the corresponding versions into a single music file that can be downloaded to the user's physical storage device or memory. The music generator may also store the segment points in the customer database (52), which may be used to track user preferences and leverage selection data. This enables future downloads of the same compilation to be made directly from the music database, rather than requiring recomputation of a completed song file.

Once the song has been purchased by a user, the user may be able to select a sharing option using the user interface, thereby allowing them to post streaming segments of their version to a social networking site. Other users may be able to sample these posted versions, and either buy them outright, or click through to the server to create and purchase their own version.

Upon completion of playback and choice input, the user may broadcast their customized song via interactions with various social networking platforms. Social networking integration can be configured upon registration by a user with the server of the present invention. For example, a user may provide social network login information for a plurality of social network platforms that can be used by the server using APIs. The server can broadcast the song selections for the user using the social networking platforms.

Pre-recorded messages may be provided to the user along with the ability to create a customized message that can be disseminated along with a link to the completed song file.

The user registration information and the login information can be stored to the customer database for later use and for tracking user behavior. Users may also be requested to provide personal and demographic information that can also be stored to the customer database.

The analytic engine may conduct analytics including tracking trends in user behavior across a plurality of users. The analytic engine may obtain user behavior from the customer database to provide data on which song compilations (customized songs) are being created, along with statistics for top song and trending of how the top song is changing, which can be further broken down by user demographics.

Future version selections can also be adaptive to user behavior. For example, the analytic engine may provide information that detects that a particular user prefers a particular type of music selection for a chorus. During playback of future songs, the segments can be defaulted to the preferred type of music for that user. The option of whether to enable this type of function can be provided to the artist, to enable artists to set defaults that override the detected user preference.

In an alternate implementation, the user may download all the possible permutations of a given song (for example with a flat fee), and can then work with the malleable file as they see fit.

Search, analytics and/or advertisement engines may also be provided. These service engines may function to track, measure and search the information database and may be augmented by the customer database (52) and/or advertising database (54).

The analytic engine, for example, may be operable to provide analytic information regarding customers, based on the customer database (52). The analytic engine may provide to artists and labels information regarding customers who have downloaded their content. For example, the information could relate to the relative popularity of particular versions comprising the content. It could also include whether previous selected versions are correlated with current or future versions (for example, if the customer picked a hard rock version in an earlier downloading session are they likely to choose it again). It could also include the number of songs that have been downloaded, sales figures, or demographic breakdowns of any of the provided information.

The analytic engine provides information including but not limited to the specific song combinations that are being downloaded by users (including full user demographic information), which are most popular, where the combinations were created (GPS coordinates or other location information), when the combinations were created, and which social networks were the combinations shared on. Artists and record labels can use this data to determine what might sell before releasing products and booking venues for tours.

A search engine may be operable to provide search functionality, for example based on artists, song titles, usernames, song lengths, genres, etc.

An advertisement engine may deliver advertisements and may be linked to the advertising database for providing the advertisements.

We claim:

1. A system for enabling a user to create an alternate version of content defined by a plurality of segments, the system comprising:
(a) a server linked to a music database;
(b) a configuration tool linked to the server, the configuration tool enabling a content owner to provide to the server a plurality of different versions of content divided into segments that correspond to the segments of the alternate version, the different versions of content being stored by the server in the music database; and
(c) a user interface enabling the user to create the alternate version of the content by selecting, for each of the segments of the alternate version, one of the different versions, the server operable to assemble the alternate version from the different versions of content stored in the music database.

2. The system of claim 1, wherein the user creates the alternate version using segments from at least two of the different versions.

3. The system of claim 1, wherein the content is audio, video, or text.

4. The system of claim 1, further comprising a social networking platform application programming interface linked to the server, the social networking platform application programming interface enabling the server to broadcast a user selection of the alternate version by a social network account of the user.

5. The system of claim 4, wherein the broadcast includes a preconfigured or customized message and a link to the alternate version.

6. The system of claim 1, further comprising an analytic engine linked to the server, the analytic engine operable to track user behavior.

7. The system of claim 6, wherein tracking the user behavior provides a determination of which different versions of content and alternate versions are most popular, where alternate versions are created, when alternate versions are created and trends in creation of alternate versions.

8. The system of claim 6, wherein the server is operable to use the user behavior to select one of the plurality of different versions as the default version for a particular segment.

9. The system of claim 1, wherein the user interface is accessible by a mobile device.

10. The system of claim 1, wherein the user interface is accessible from a music management application that interfaces with the server by an application programming interface.

11. A computer-implemented method for enabling a user to create an alternate version of content defined by a plurality of segments, the method comprising the steps of:
(a) enabling a content owner to provide to a server a plurality of different versions of content divided into segments that correspond to the segments of the alternate version, the different versions of content being stored by the server; and
(b) enabling, by means of a user interface linked to the server, the user to create the alternate version of the content by selecting, for each of the segments of the alternate version, one of the different versions, the server operable to assemble the alternate version from the different versions of content stored.

12. The computer-implemented method of claim 11, wherein the user creates the alternate version using segments from at least two of the different versions.

13. The computer-implemented method of claim 11, wherein the user selects the alternate versions for each of the segments in real time during playback of the content using the user interface.

14. The computer-implemented method of claim 13, wherein the user interface prevents the user from making a selection for a particular segment when only one version of content is provided for that segment.

15. The computer-implemented method of claim 11, comprising the further step of enabling the user to initiate a broadcast of the user's selection of the alternate version by a social network account of the user.

16. The computer-implemented method of claim 15, wherein the broadcast includes a preconfigured or customized message and a link to the alternate version.

17. The computer-implemented method of claim 11, comprising the further step of tracking user behavior to determine which different versions of content and alternate versions are most popular, where alternate versions are created, when alternate versions are created and trends in creation of alternate versions.

18. The computer-implemented method of claim 11, comprising the further step of enabling the content owner to customize the user interface.

19. The computer-implemented method of claim 18, wherein the customization includes customizing a background image of the user interface, color schemes for user controls in the user interface, icons to access commands in the user interface, and metadata for the different content versions.

20. The computer-implemented method of claim 11, wherein the user interface is operable to enable the selection based on selective movement of an accelerometer and/or gyroscope.
